(19) United States
(12) Patent Application Publication
(10) Pub. No.: US 2016/0170085 A1
(43) Pub. Date: Jun. 16, 2016

(54) 2.75D MESHING ALGORITHM

(71) Applicant: Landmark Graphics Corporation, Houston, TX (US)

(72) Inventors: Steven Bryan Ward, Austin, TX (US); Michael Loyd Brewer, Katy, TX (US)

(21) Appl. No.: 14/888,401

(22) PCT Filed: Jul. 2, 2013
(86) PCT No.: PCT/US2013/049150

§ 371 Date: Oct. 30, 2015

(51) Int. Cl. G01V 99/00

(52) U.S. Cl. CPC G01V 99/005

(57) ABSTRACT

The disclosed embodiments include a method, apparatus, and computer program product for generating hybrid computational meshes around complex and discrete fractures for the purpose of reservoir simulation. For example, one disclosed embodiment is a computer-implemented method for modeling three-dimensional (3D) geological fractures. The method includes receiving a set of 3D fracture surfaces with geometry that has been discretized in a two-dimensional (2D) manifold by a collection of polygons. The method defines a family of non-intersecting 2D slicing surfaces for slicing the set of 3D fracture surfaces. The method then uses the intersection of the 2D slicing surface with the 2D manifolds defining the fracture surfaces to create a set of 2D fractures on each slicing surface. Following a series of steps, the method logically connects 2D fracture cells corresponding to each fracture from each slicing surface to its above/below neighbors to simulate three-dimensional geology using two-dimensional elements.

### BACKGROUND OF THE INVENTION

1. Field of the Invention

The present invention generally relates to a system and method for generating a grid that can be used to construct a simulation model of a subsurface reservoir, and more particularly, to a system and method configured for modeling geological fractures.

2. Discussion of the Related Art

In the oil and gas industry, reservoir modeling involves the construction of a computer model of a petroleum reservoir for the purposes of improving estimation of reserves and making decisions regarding the development of the field. For example, geological models may be created to provide a static description of the reservoir prior to production. In contrast, reservoir simulation models may be created to simulate the flow of fluids within the reservoir over its production lifetime.

One challenge with reservoir simulation models is the modeling of fractures within a reservoir, which requires a thorough understanding of matrix flow characteristics, fracture network connectivity and fracture-matrix interaction. Fractures can be described as open cracks or voids within the formation and can either be naturally occurring or artificially generated from a wellbore. The correct modeling of the fractures is important as the properties of fractures such as spatial distribution, aperture, length, height, conductivity, and connectivity significantly affect the flow of reservoir fluids to the well bore.

Accordingly, the disclosed embodiments provide a system, method, and computer program product for generating hybrid computational meshes around complex and discrete fractures for the purpose of reservoir simulation.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an image of three-dimensional fractures that are modeled in accordance with the disclosed embodiments;

FIG. 2 is a flow diagram illustrating a method for modeling three-dimensional fractures in accordance with a disclosed embodiment;

FIG. 3 illustrates an example of a set of non-intersecting 2D slicing surfaces intersecting a set of discretized two-dimensional fractures/manifolds in accordance with the disclosed embodiments;

FIG. 3A illustrates an example a set of non-intersecting 2D slicing surfaces intersecting a single perpendicular 2D fracture/manifold in accordance with the disclosed embodiments;

FIG. 3B illustrates an example a set of non-intersecting 2D slicing surfaces intersecting a single angled 2D fracture/manifold in accordance with the disclosed embodiments;

FIG. 4 illustrates an example for generating a computational mesh around a fracture line segment in accordance with the disclosed embodiments; and

FIG. 5 illustrates an example of generating computational meshes around intersecting fracture line segments in accordance with the disclosed embodiments;

FIG. 6 illustrates an example of computational meshes around a complex array of fracture line segments in accordance with the disclosed embodiments;

FIG. 7 is a block diagram illustrating one embodiment of a system for implementing the disclosed embodiments; and

FIG. 8 illustrates another example of an unstructured grid generated around complex geometries comprising of a plurality of intersecting fracture line segments in accordance with the disclosed embodiments.

### DETAILED DESCRIPTION

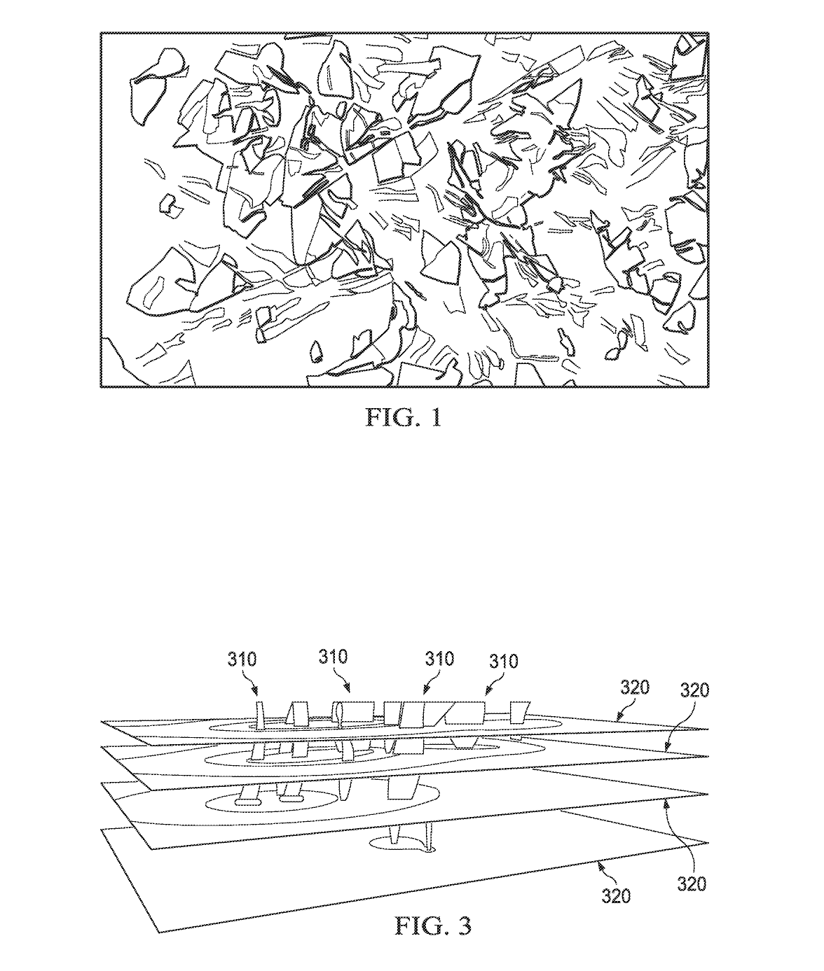

The disclosed embodiments include a system and method for modeling three-dimensional (3D) objects, such as, but not limited to, geological fractures. The disclosed embodiments and advantages thereof are best understood by referring to FIGS. 1-8 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 illustrates an image of three-dimensional fractures that are modeled in accordance with the disclosed embodiments. As can be seen in image 100, the layers of earth formation include fractures within the formation. As stated above, these fractures can be described as open cracks or voids within the formation and can either be naturally occurring or artificially generated from a wellbore. Understanding and modeling the proper characteristic of these fractures is important as the fractures enable and affect the flow of reservoir fluids to the well bore. Images such as image 100 may be obtained or generated using image logs. Image logs use a rotating transducer to measure acoustic impedance across the entire borehole wall to identify the presence and direction of rock fractures, as well as understanding the dip direction of the stratigraphy.

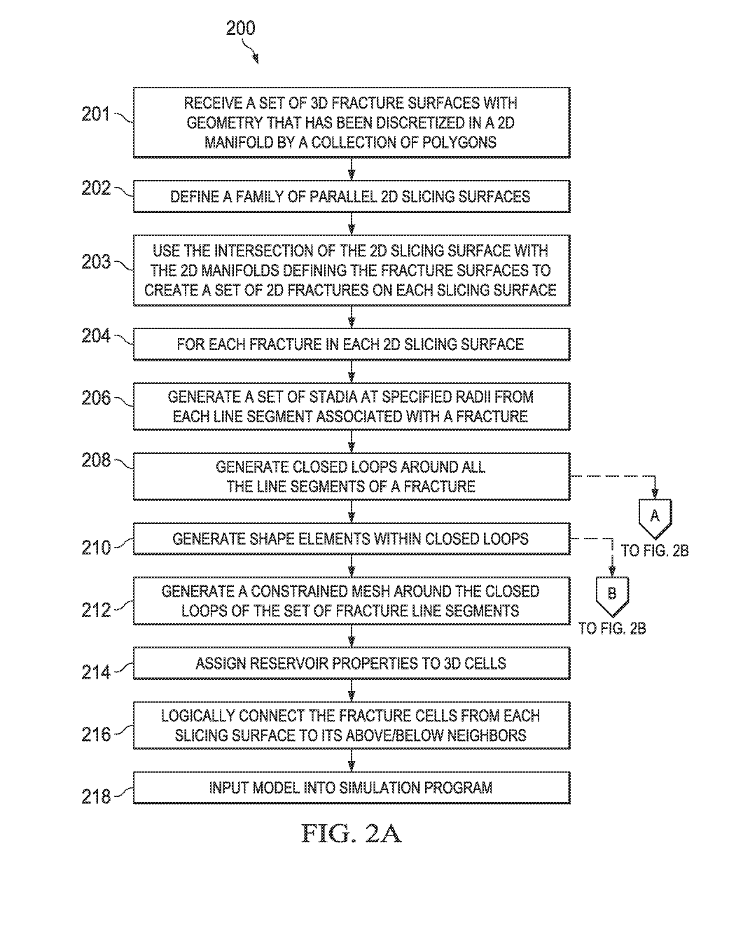

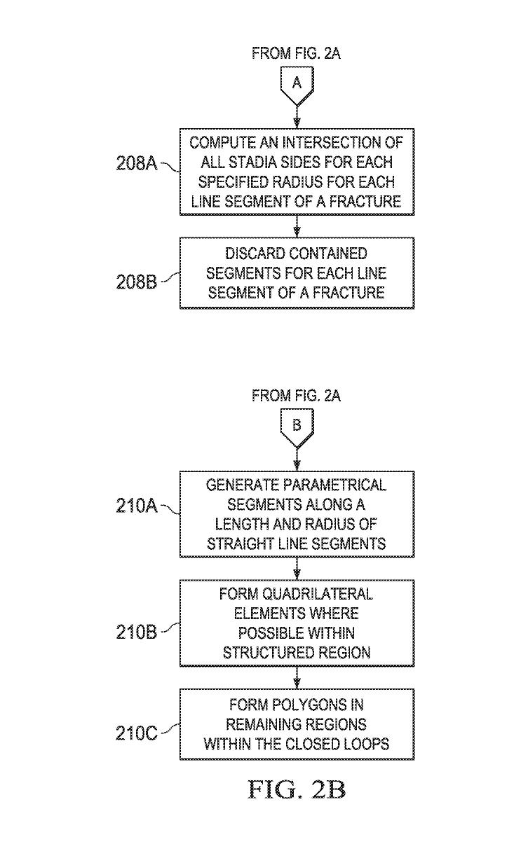

FIG. 2 is a flow diagram illustrating a method/process 200 for modeling three-dimensional fractures in accordance with a disclosed embodiment. In the depicted embodiment, the method begins by receiving a set of 3D fracture surfaces with geometry that has been discretized in a 2D manifold by a collection of polygons (step 201). In an alternative embodiment, the process 200 may begin by performing the discretization of a set of 3D fractures to generate the collection of 2D manifolds/fracture surfaces.

The method defines or includes a defined set/family of non-intersecting 2D slicing surfaces that is used to slice the set of 2D fracture surfaces (step 202). In certain embodiments, the number of slicing surfaces in a family that is used for slicing the set of 2D manifolds may be user-modifiable. Additionally, in some embodiments, the dimensions of the slicing surfaces may be user-modifiable.

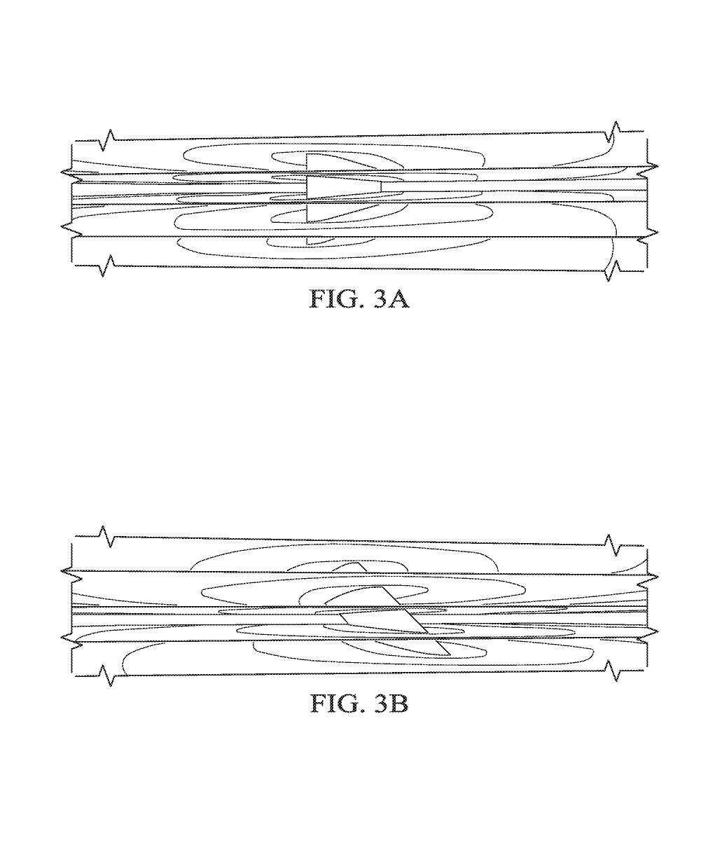

The method uses the intersection of the 2D slicing surfaces with the 2D manifolds defining the fracture surfaces to create a set of 2D fractures lines on each slicing surface (step 203). As an illustrative examples, FIG. 3 depicts a diagram illustrating an example of a set of non-intersecting 2D slicing surfaces 320 that are used to slice a set of 2D fractures/manifolds 310, FIG. 3A provides a more detailed view that illustrates an example a set of non-intersecting 2D slicing surfaces intersecting a single perpendicular 2D manifold in accordance with the disclosed embodiments, and FIG. 3B illustrates an example a set of non-intersecting 2D slicing surfaces intersecting an angled 2D manifold in accordance with the disclosed embodiments.

As stated above, a set of 2D fractures is created on each slicing surface at the intersection of the slicing surface and the set of 2D manifolds. Each 2D fracture consists of one or more fracture line segments. In accordance with the disclosed embodiment, for each fracture in a slicing surface (step 204), the method generates a set of stadia at a specified radii around each fracture line segment associated with the fracture (step 206). The method then generates, for each fracture, closed loops around all of the line segments associated with a fracture (step 208). In certain embodiments, the process of generating the closed loop around line segments associated with a fracture may include computing an intersection of all stadia sides for each specified radius for each line segment of the fracture (step 208A) and discarding the contained segments for each line segment associated with the fracture that are wholly contained by stadia of other line segments associated with the fracture (step 208B).

Following step 208, the method generates shape elements within the closed loops associated with a fracture (step 210). For example, in one embodiment, the process generates parametrical segments along a length and radius of each straight line segment (step 210A). The process then forms quadrilateral elements where possible within the structured region (step 210B) and form polygons within the remaining regions of the closed loops (step 210C).

Once the shape elements are generated, the process generates a constrained mesh around the closed loops of the set of fractures to fill the remainder of the two-dimensional surface (step 212). In one embodiment, a Delaunay triangulation algorithm is utilized to generate the constrained mesh around the closed loops of the set of fracture line segments. Thus, each of the two-dimensional surfaces now consists entirely of two-dimensional cell elements that are contained in the set of fractures or the constrained mesh.

From here, the process can assign reservoir properties such as, but not limited to, porosity and permeability, to each of the two-dimensional cells for modeling the fluid flow of the reservoir (step 214). These property values may be manually entered by a user or may be automatically extracted from well logs or from databases containing the pertinent geological information.

In addition, in accordance with the disclosed embodiments, the two-dimensional cells within a fracture are assigned a thickness attribute value (i.e., the topological two-dimensional fracture can be assigned a volume) that allows for three-dimensional communications within the fracture to communicate. Thus, the disclosed embodiments does not require that the two-dimensional cells on a slicing surface be extruded to a third dimension for creating three-dimensional cells, but instead assigns that attribute to the two-dimensional cells to enable computation/simulation similar to that of a three-dimensional cell.

At step 216, the process logically connects the fracture cells corresponding to the same fracture from each slicing surface to its above/below slicing surface neighbors. In one embodiment, the physics of the flow within the fractures and their interactions with each other is fully captured in three dimension by using a volume/thickness attribute assigned to each two-dimensional cell within the fracture and computing their intersection, whereas, the physics of the flow within the matrix is restricted under the assumption that the permeability normal to the bedding plane is extremely low. This effectively makes the velocities in that direction negligible compared to the velocities tangential to the bedding plane, i.e., kz=0, Vz=0, kh>0, Vh<>0. In other words, under these conditions, the model can simulate the condition of no vertical flow outside of the fractures.

Finally, the process can input the three-dimensional cellular model into a simulation program, such as, but not limited to, Nexus® reservoir simulation software, for performing numerical simulation and for assessing the fluid flow (step 218), with process 200 terminating thereafter.

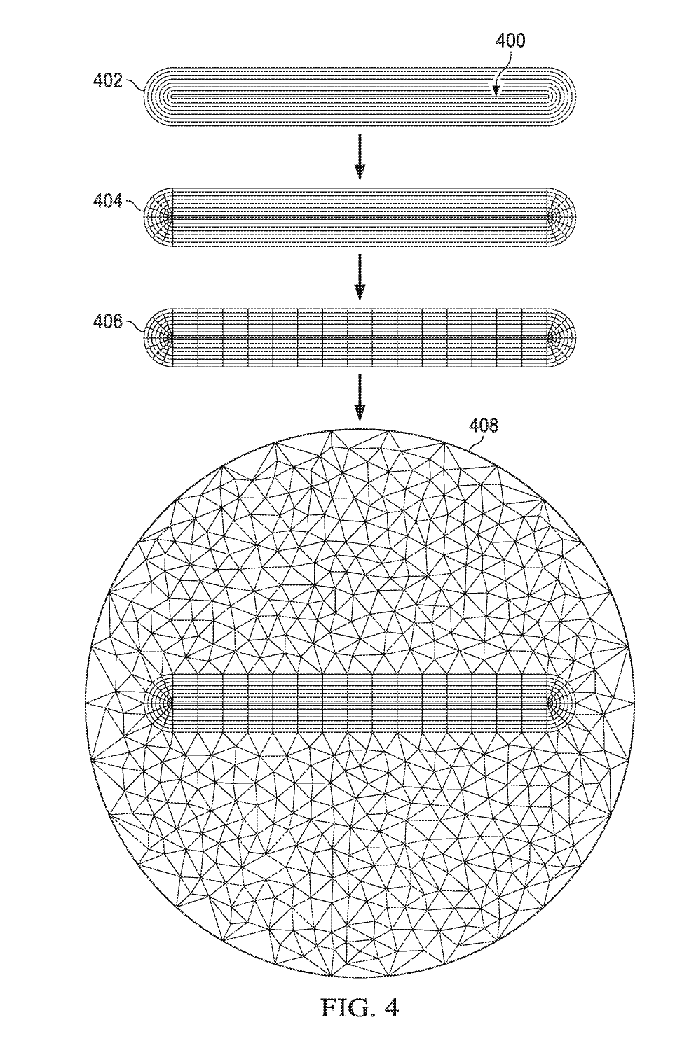

FIG. 4 provides an illustrative view of generating a computational mesh around a single fracture line segment in accordance with the disclosed embodiments. Beginning with diagram 402, a set of stadia is generated around a line segment 400. As can be seen by diagram 402, each stadium in the set of stadia consists of two linear sides connected by two arcs to completely enclose the straight line segment. The distance from each side to the straight line segment is a constant radius. In certain embodiments, the radius distance may be a user modifiable variable value.

In diagram 404, parametrical segments along a length and radius of each straight line segment is generated in accordance with step 210A of the process 200. Quadrilateral elements are then form where possible within the structured region as referenced in step 210B of the process 200. Diagram 408 illustrates the constrained mesh generated around the closed loops of the line segment 400.

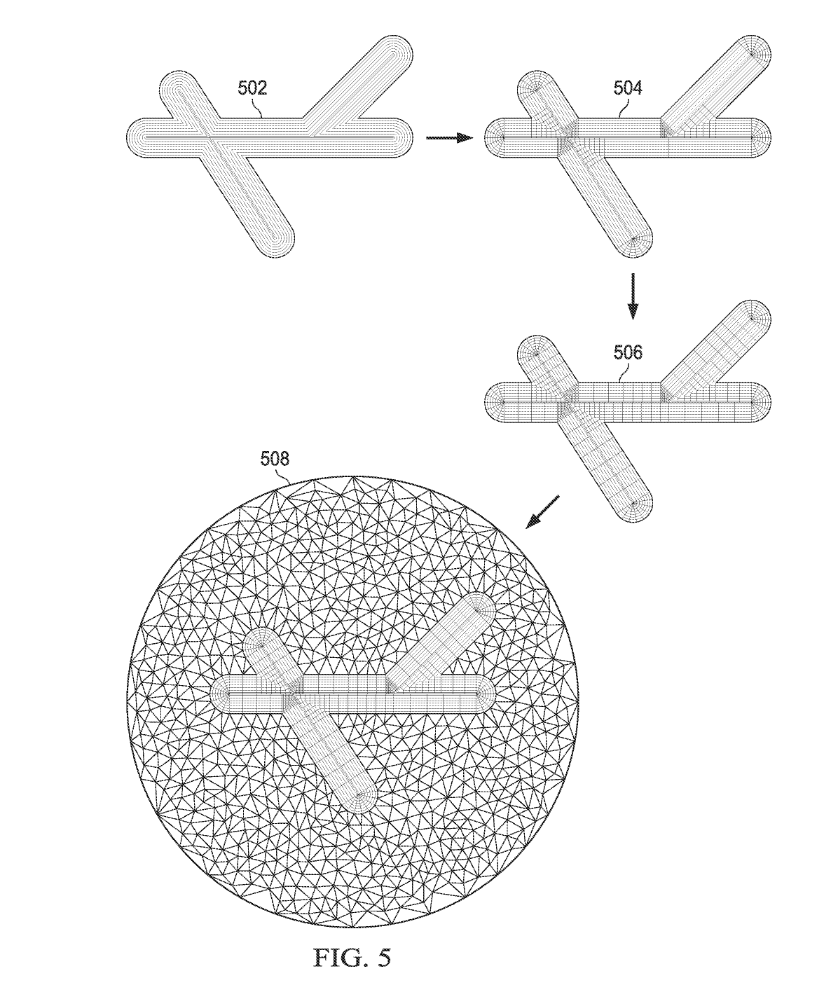

FIG. 5 provides another illustrative view of generating computational meshes around intersecting fracture line segments in accordance with the disclosed embodiments. For instance, diagram 502 illustrates a set of stadia generated around three intersecting fracture line segments. The result of diagram 502 required that the process compute an intersection of all stadia sides for each specified radius for each of the intersecting fracture line segment as referenced in step 208A and discard the contained segments for each fracture line segment that are wholly contained by stadia of other fracture line segments as referenced in step 208B.

Diagram 504 illustrates the results of generating shape elements within the closed loops of the fracture line segments as referenced in step 210. As can be seen, parametrical segments along a length and radius of each fracture line segment is generated in accordance with step 210A. In diagram 506, quadrilateral elements are formed where possible within the structured region as referenced in step 210B. In addition, polygons are formed within the remaining regions of the closed loops of the fracture line segments as stated in step 210C. Diagram 508 illustrates a constrained mesh generated around the closed loops of the intersecting fracture line segments as referenced in step 212 of process 200.

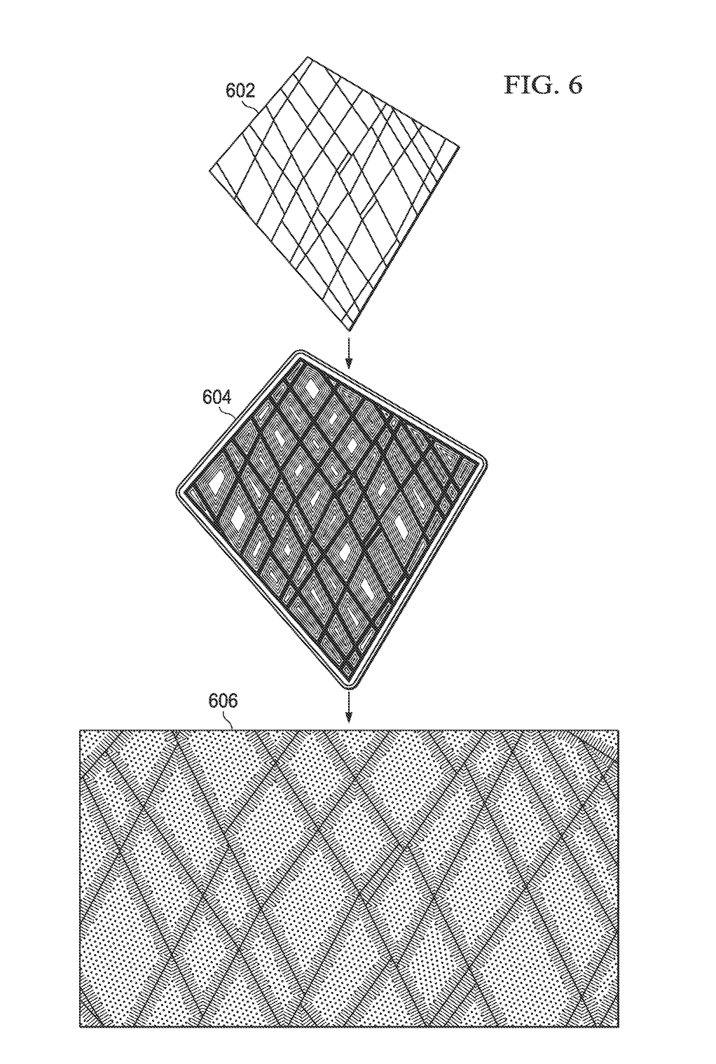

As another example, FIG. 6 illustrates generating an unstructured grid around a complex array of fracture line segments in accordance with the disclosed embodiments. Diagram 602 indicates a set of fractures with geometry that has been discretized in a two-dimensional surface by a collection of line segments. Diagram 604 illustrates the results of a set of stadia being generated around each of the fracture line segments. Diagram 606 illustrates an exploded view of the fracture line segments as a result of performing the remaining process described in FIG. 2.

As can be seen from FIG. 6, the disclosed algorithm can quickly generate unstructured grids using structured elements around complex geometries. As previously stated, the two-dimension cells of a fracture may be assigned a volume attribute value for logically enabling two-dimensional cells of a fracture on adjacent two-dimensional surface to communicate.

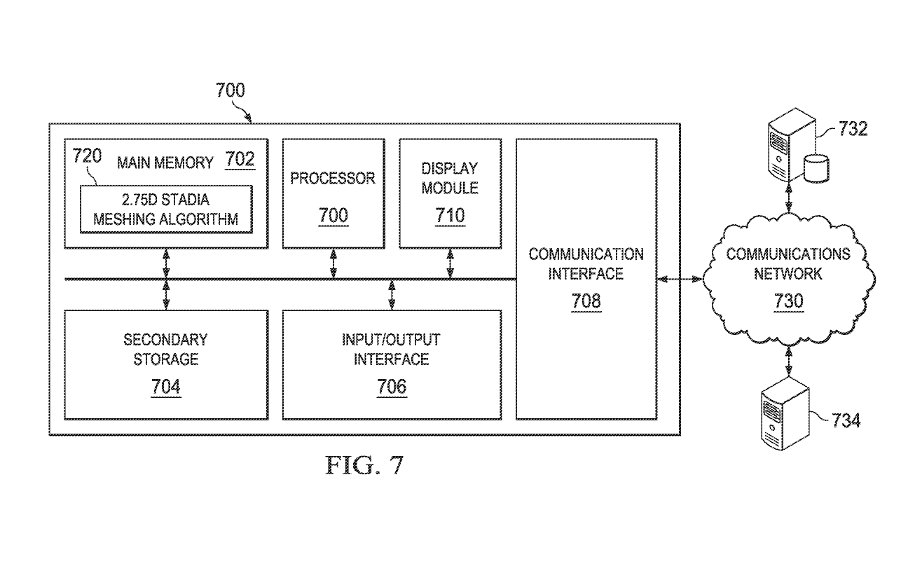

FIG. 7 is a block diagram illustrating one embodiment of a system 700 for implementing the features and functions of the disclosed embodiments. The system 700 includes, among other components, a processor 700, main memory 702, secondary storage unit 704, an input/output interface module 706, and a communication interface module 708. The processor 700 may be any type or any number of single core or multi-core processors capable of executing instructions for performing the features and functions of the disclosed embodiments.

The input/output interface module 706 enables the system 700 to receive user input (e.g., from a keyboard and mouse) and output information to one or more devices such as, but not limited to, printers, external data storage devices, and audio speakers. The system 700 may optionally include a separate display module 710 to enable information to be displayed on an integrated or external display device. For instance, the display module 710 may include instructions or hardware (e.g., a graphics card or chip) for providing enhanced graphics, touchscreen, and/or multi-touch functionalities associated with one or more display devices.

Main memory 702 is volatile memory that stores currently executing instructions/data, or instructions/data that are prefetched for execution. The secondary storage unit 704 is non-volatile memory for storing persistent data. The secondary storage unit 704 may be or include any type of data storage component such as a hard drive, a flash drive, or a memory card. In one embodiment, the secondary storage unit 704 stores the computer executable code/instructions and other relevant data for enabling a user to perform the features and functions of the disclosed embodiments.

For example, in accordance with the disclosed embodiments, the secondary storage unit 704 may permanently store the executable code/instructions of the above-described stadia meshing algorithm 720 for modeling three-dimensional (3D) objects such as, but not limited to, geological fractures. The instructions associated with the stadia meshing algorithm 720 are then loaded from the secondary storage unit 704 to main memory 702 during execution by the processor 700 as illustrated in FIG. 7.

The communication interface module 708 enables the system 700 to communicate with the communications network 730. For example, the network interface module 708 may include a network interface card and/or a wireless transceiver for enabling the system 700 to send and receive data through the communications network 730 and/or directly with other devices.

The communications network 730 may be any type of network including a combination of one or more of the following networks: a wide area network, a local area network, one or more private networks, the Internet, a telephone network such as the public switched telephone network (PSTN), one or more cellular networks, and wireless data networks. The communications network 730 may include a plurality of network nodes (not depicted) such as routers, network access points/gateways, switches, DNS servers, proxy servers, and other network nodes for assisting in routing of data/communications between devices.

For example, in one embodiment, the system 700 may interact with one or more servers 734 or databases 732 for performing the features of the present invention. For instance, the system 700 may query the database 732 for geological information for assigning reservoir properties to cells for performing a simulation. The system 700 may query the database 732 for well log information for determining fracture orientation or density for enabling modeling of the fractures in accordance with the disclosed embodiments. Further, in certain embodiments, the system 700 may act as a server system for one or more client devices or a peer system for peer to peer communications or parallel processing with one or more devices.

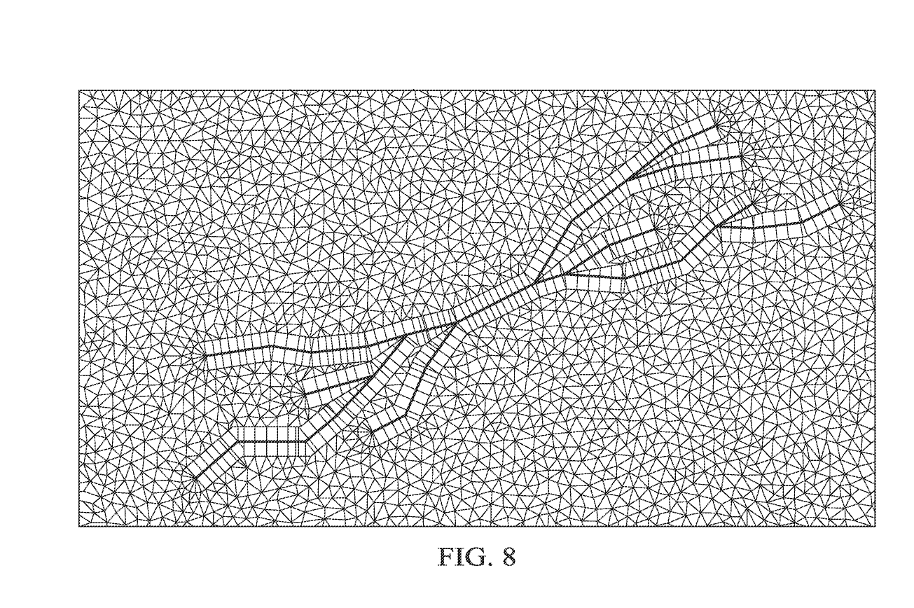

Accordingly, as described above, advantages of the disclosed embodiments include, but are not limited to, providing fast generation of unstructured grids with structured elements around complex geometries. In addition, low expertise is required on the part of the user to be able to utilize the disclosed embodiments to generate high quality grid cells that are suitable for many numeric simulators. For instance, the disclosed embodiments enable workflows for non-experts to use advanced numeric modeling techniques for complicated geometries that would have previously required users to make gross approximations and/or require per-use assistance from numeric modeling experts. As another example, FIG. 8 illustrates another example of complex geometries involving a plurality of intersecting fracture line segments in which the disclosed embodiments may quickly generate a two-dimensional grid cell that may be extruded into three-dimensional elements for performing numeric simulations in accordance with the disclosed embodiments.

While specific details about the above embodiments have been described, the above hardware and software descriptions are intended merely as example embodiments and are not intended to limit the structure or implementation of the disclosed embodiments. For instance, although many other internal components of the system 700 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Those skilled in the art will recognize that the present teachings are amenable to a variety of modifications and/or enhancements. While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. Such modifications are intended to be covered within the true scope of the present teachings.

In addition, the flowchart and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The disclosed embodiments include a method, apparatus, and computer program product for generating hybrid computational meshes around complex and discrete fractures for the purpose of reservoir simulation. For example, one disclosed embodiment is a computer-implemented method for modeling three-dimensional (3D) geological fractures. The method includes the steps of receiving a set of 3D fracture surfaces with geometry that has been discretized in a two-dimensional (2D) manifold by a collection of polygons. The method defines a family of non-intersecting 2D slicing surfaces for slicing the set of 3D fracture surfaces. The method then uses the intersection of the 2D slicing surface with the 2D manifolds defining the fracture surfaces to create a set of 2D fractures on each slicing surface. The method generates closed loops around all the line segments associated with each fracture on each slicing surface using a set of stadia and further generates shape elements within the closed loops. A constrained mesh around the closed loops of the set of fracture is generated to fill in a remainder space on each slicing surface. The method then logically connects the fracture cells corresponding to each fracture from each slicing surface to its neighbors. Reservoir properties or attributes can then be assigned to each of the 3D cells for performing reservoir simulations.

The computer-implemented method may further comprise establishing communication between 2D cells of a fracture on adjacent 2D discretized slice surfaces comprises assigning a volume attribute value to each 2D cell of the fracture to simulate three-dimensional geology. Generating the closed loops around all of the straight line segments of the fracture line segment may further comprise, for each straight line segment in each fracture line segment, computing an intersection of all stadia sides for each specified radius, identifying contained segments for each straight line segment in each fracture line segment that are wholly contained by stadia of other line segments in the fracture line segment, and discarding the contained segments for each line segment in the fracture line segment resulting in closed loops around line segments in the fracture line segment. Generating the various shape cells within the closed loops of the straight line segment may further comprise generating parametrical segments along a length and radius of the straight line segment within the closed loops of the straight line segment, generating quadrilateral elements where possible within the closed loops of the straight line segment, and generating polygons in remaining regions within the closed loops of the straight line segment. Generating the constrained cell mesh around the closed loops of the set of fracture line segments to fill in the remainder space of the 2D slicing surface may be implemented using a Delaunay triangulation algorithm. In some embodiments, each stadium in the set of stadia consists of two linear sides connected by two arcs to completely enclose the straight line segment, and a distance from each side to the straight line segment is a constant radius. In other embodiments, the computer-implemented method may include inputting the discretized slice surface into a numeric simulation program, or computing an intersection of the 2D cells of the fracture based on the volume attribute value for establishing communication between 2D cells of the fracture on adjacent 2D discretized slice surfaces.

In yet another embodiment, a non-transitory computer readable medium comprises computer executable instructions for modeling a three-dimensional (3D) structure. The computer executable instructions when executed causes one or more machines to perform operations including receiving a 3D domain that includes discretized two-dimensional (2D) fracture surfaces representative of the 3D geological fractures. The 3D domain is intersected with a set of non-intersecting 2D slicing surfaces to generate a set of 2D fracture line segments on each 2D slicing surface at the intersection of a respective 2D slicing surface and the 2D fracture surfaces. For each 2D slicing surface and for each straight line segment in each fracture line segment of the set of fracture line segments, a set of stadia is generated at a specified radii from a straight line segment, closed loops are generated around all the straight line segments of the fracture line segment, and various shape cells are generated within the closed loops of the straight line segment. For each 2D slicing surface, a constrained cell mesh is generated around the closed loops of the set of fracture line segments to fill in a remainder space of the 2D slicing surface to produce a discretized slice surface, reservoir properties and a volume attribute are assigned to each cell within the discretized slice surface, and communication is established between cells of a fracture on adjacent 2D discretized slice surfaces. In another embodiment, the computer readable medium further comprises computer executable instructions that when executed causes the one or more machines to substitute one or more segments of fracture line segment using one or more straight line segments to approximate a curvature of the fracture line segment. The computer executable instructions for generating the closed loops around all of the straight line segments of the fracture line segment may comprise, for each straight line segment in each fracture line segment, computing an intersection of all stadia sides for each specified radius, identifying contained segments for each straight line segment in each fracture line segment that are wholly contained by stadia of other line segments in the fracture line segment, and discarding the contained segments for each line segment in the fracture line segment resulting in closed loops around line segments in the fracture line segment. In another embodiment, The computer executable instructions for generating the various shape cells within the closed loops of the straight line segment may comprise generating parametrical segments along a length and radius of the straight line segment within the closed loops of the straight line segment, generating quadrilateral elements where possible within the closed loops of the straight line segment, and generating polygons in remaining regions within the closed loops of the straight line segment. In still another embodiment, the computer executable instructions for generating the constrained cell mesh around the closed loops of the set of fracture line segments to fill in the remainder space of the 2D slicing surface may be implemented using a Delaunay triangulation algorithm. The computer executable instructions for each stadium in the set of stadia may include two linear sides connected by two arcs to completely enclose the straight line segment, and a distance from each side to the straight line segment may be a constant radius. In another embodiment, the computer readable medium may further include computer executable instructions that when executed causes the one or more machines to input the discretized slice surface into a numeric simulation program.

In another embodiment, a system include at least one processor and at least one memory coupled to the at least one processor and storing computer executable instructions. When executed by the at least one processor, the computer executable instructions perform operations comprising receiving a 3D domain that includes discretized two-dimensional (2D) fracture surfaces representative of the 3D geological fractures. The 3D domain is intersected with a set of non-intersecting 2D slicing surfaces to generate a set of 2D fracture line segments on each 2D slicing surface at the intersection of a respective 2D slicing surface and the 2D fracture surfaces. For each 2D slicing surface and for each straight line segment in each fracture line segment of the set of fracture line segments, a set of stadia is generated at a specified radii from a straight line segment, closed loops are generated around all the straight line segments of the fracture line segment, and various shape cells are generated within the closed loops of the straight line segment. For each 2D slicing surface, a constrained cell mesh is generated around the closed loops of the set of fracture line segments to fill in a remainder space of the 2D slicing surface to produce a discretized slice surface and reservoir properties and a volume attribute are assigned to each cell within the discretized slice surface. Communication is established between cells of a fracture on adjacent 2D discretized slice surfaces.

In other embodiments, computer executable instructions is provided for substituting one or more segments of fracture line segment using one or more straight line segments to approximate a curvature of the fracture line segment. The computer executable instructions for generating the closed loops around all of the straight line segments of the fracture line segment may include, for each straight line segment in each fracture line segment, computing an intersection of all stadia sides for each specified radius, identifying contained segments for each straight line segment in each fracture line segment that are wholly contained by stadia of other line segments in the fracture line segment, and discarding the contained segments for each line segment in the fracture line segment resulting in closed loops around line segments in the fracture line segment. In another embodiment, the computer executable instructions for generating the various shape cells within the closed loops of the straight line segment may comprise generating parametrical segments along a length and radius of the straight line segment within the closed loops of the straight line segment, generating quadrilateral elements where possible within the closed loops of the straight line segment, and generating polygons in remaining regions within the closed loops of the straight line segment. In still another embodiment, computer executable instructions may be provided for inputting the discretized slice surface into a numeric simulation program.

One advantage of the disclosed embodiments is that the embodiments enable fast generation of unstructured grids with structured elements around complex geometries.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A computer-implemented method for modeling three-dimensional (3D) geological fractures, the method comprising:
receiving a 3D domain that includes discretized two-dimensional (2D) fracture surfaces representative of the 3D geological fractures;
intersecting the 3D domain with a set of non-intersecting 2D slicing surfaces to generate a set of 2D fracture line segments on each 2D slicing surface at the intersection of a respective 2D slicing surface and the 2D fracture surfaces;
for each 2D slicing surface:
for each straight line segment in each fracture line segment of the set of fracture line segments: generating a set of stadia at a specified radii from a straight line segment, generating closed loops around all the straight line segments of the fracture line segment, and generating various shape cells within the closed loops of the straight line segment;
generating a constrained cell mesh around the closed loops of the set of fracture line segments to fill in a remainder space of the 2D slicing surface to produce a discretized slice surface; and
assigning reservoir properties and a volume attribute to each 2D cell within the discretized slice surface; and
establishing communication between 2D cells of a fracture on adjacent 2D discretized slice surfaces.

2. The computer-implemented method of claim 1 further comprising establishing communication between 2D cells of a fracture on adjacent 2D discretized slice surfaces comprises assigning a volume attribute value to each 2D cell of the fracture to simulate three-dimensional geology.

3. The computer-implemented method of claim 1, wherein generating the closed loops around all of the straight line segments of the fracture line segment comprises for each straight line segment in each fracture line segment:
computing an intersection of all stadia sides for each specified radius;
identifying contained segments for each straight line segment in each fracture line segment that are wholly contained by stadia of other line segments in the fracture line segment; and
discarding the contained segments for each line segment in the fracture line segment resulting in closed loops around line segments in the fracture line segment.

4. The computer-implemented method of claim 1, wherein generating the various shape cells within the closed loops of the straight line segment comprises:
generating parametrical segments along a length and radius of the straight line segment within the closed loops of the straight line segment;
generating quadrilateral elements where possible within the closed loops of the straight line segment; and
generating polygons in remaining regions within the closed loops of the straight line segment.

5. The computer-implemented method of claim 1, wherein generating the constrained cell mesh around the closed loops of the set of fracture line segments to fill in the remainder space of the 2D slicing surface is implemented using a Delaunay triangulation algorithm.

6. The computer-implemented method of claim 1, wherein each stadium in the set of stadia consists of two linear sides connected by two arcs to completely enclose the straight line segment, and wherein a distance from each side to the straight line segment is a constant radius.

7. The computer-implemented method of claim 1, further comprising inputting the discretized slice surface into a numeric simulation program.

8. The computer-implemented method of claim 2, further comprising computing an intersection of the 2D cells of the fracture based on the volume attribute value for establishing communication between 2D cells of the fracture on adjacent 2D discretized slice surfaces.

9. A non-transitory computer readable medium comprising computer executable instructions for modeling a three-dimensional (3D) structure, the computer executable instructions when executed causes one or more machines to perform operations comprising:
receiving a 3D domain that includes discretized two-dimensional (2D) fracture surfaces representative of the 3D geological fractures;
intersecting the 3D domain with a set of non-intersecting 2D slicing surfaces to generate a set of 2D fracture line segments on each 2D slicing surface at the intersection of a respective 2D slicing surface and the 2D fracture surfaces;
for each 2D slicing surface:
for each straight line segment in each fracture line segment of the set of fracture line segments: generating a set of stadia at a specified radii from a straight line segment, generating closed loops around all the straight line segments of the fracture line segment, and generating various shape cells within the closed loops of the straight line segment;
generating a constrained cell mesh around the closed loops of the set of fracture line segments to fill in a remainder space of the 2D slicing surface to produce a discretized slice surface; and
assigning reservoir properties and a volume attribute to each cell within the discretized slice surface; and
establishing communication between cells of a fracture on adjacent 2D discretized slice surfaces.

10. The computer readable medium of claim 9, further comprising computer executable instructions that when executed causes the one or more machines to substitute one or more segments of fracture line segment using one or more straight line segments to approximate a curvature of the fracture line segment.

11. The computer readable medium of claim 9, wherein the computer executable instructions for generating the closed loops around all of the straight line segments of the fracture line segment comprises:
for each straight line segment in each fracture line segment:
computing an intersection of all stadia sides for each specified radius;
identifying contained segments for each straight line segment in each fracture line segment that are wholly contained by stadia of other line segments in the fracture line segment; and
discarding the contained segments for each line segment in the fracture line segment resulting in closed loops around line segments in the fracture line segment.

12. The computer readable medium of claim 9, wherein the computer executable instructions for generating the various shape cells within the closed loops of the straight line segment comprises:
generating parametrical segments along a length and radius of the straight line segment within the closed loops of the straight line segment
generating quadrilateral elements where possible within the closed loops of the straight line segment; and
generating polygons in remaining regions within the closed loops of the straight line segment.

13. The computer readable medium of claim 9, wherein the computer executable instructions for generating the constrained cell mesh around the closed loops of the set of fracture line segments to fill in the remainder space of the 2D slicing surface is implemented using a Delaunay triangulation algorithm.

14. The computer readable medium of claim 9, wherein the computer executable instructions for each stadium in the set of stadia consists of two linear sides connected by two arcs to completely enclose the straight line segment, and wherein a distance from each side to the straight line segment is a constant radius.

15. The computer readable medium of claim 9, further comprising computer executable instructions that when executed causes the one or more machines to input the discretized slice surface into a numeric simulation program.

16. A system, comprising:
at least one processor; and
at least one memory coupled to the at least one processor and storing computer executable instructions that when executed by the at least one processor performs operations comprising:
receiving a 3D domain that includes discretized two-dimensional (2D) fracture surfaces representative of the 3D geological fractures;
intersecting the 3D domain with a set of non-intersecting 2D slicing surfaces to generate a set of 2D fracture line segments on each 2D slicing surface at the intersection of a respective 2D slicing surface and the 2D fracture surfaces;
for each 2D slicing surface;
for each straight line segment in each fracture line segment of the set of fracture line segments: generating a set of stadia at a specified radii from a straight line segment, generating closed loops around all the straight line segments of the fracture line segment, and generating various shape cells within the closed loops of the straight line segment;
generating a constrained cell mesh around the closed loops of the set of fracture line segments to fill in a remainder space of the 2D slicing surface to produce a discretized slice surface; and
assigning reservoir properties and a volume attribute to each cell within the discretized slice surface; and
establishing communication between cells of a fracture on adjacent 2D discretized slice surfaces.

17. The system of claim 16, further comprising computer executable instructions for substituting one or more segments of fracture line segment using one or more straight line segments to approximate a curvature of the fracture line segment.

18. The system of claim 16, wherein the computer executable instructions for generating the closed loops around all of the straight line segments of the fracture line segment comprises:
for each straight line segment in each fracture line segment:
computing an intersection of all stadia sides for each specified radius;
identifying contained segments for each straight line segment in each fracture line segment that are wholly contained by stadia of other line segments in the fracture line segment; and
discarding the contained segments for each line segment in the fracture line segment resulting in closed loops around line segments in the fracture line segment.

19. The system of claim 16, wherein the computer executable instructions for generating the various shape cells within the closed loops of the straight line segment comprises:
generating parametrical segments along a length and radius of the straight line segment within the closed loops of the straight line segment
generating quadrilateral elements where possible within the closed loops of the straight line segment; and
generating polygons in remaining regions within the closed loops of the straight line segment.

20. The system of claim 16, further comprising computer executable instructions for inputting the discretized slice surface into a numeric simulation program.
